(19) United States
(12) Patent Application Publication
(10) Pub. No.: US 2016/0276914 A1
(43) Pub. Date: Sep. 22, 2016

(54) Multi-Axis Levitating Vibration Energy Harvester

(71) Applicant: Purdue Research Foundation, West Lafayette, IN (US)

(72) Inventors: Dimitrios Peroulis, West Lafayette, IN (US); Sean M. Scott, West Lafayette, IN (US); David Francis Berdy, West Lafayette, IN (US); Nithin Raghunathan, West Lafayette, IN (US)

(73) Assignee: Purdue Research Foundation, West Lafayette, IN (US)

(21) Appl. No.: 14/972,494

(22) Filed: Dec. 17, 2015

Related U.S. Application Data
(60) Provisional application No. 62/094,003, filed on Dec. 18, 2014.

(51) Int. Cl. H02K 35/00; H02K 1/34; H02K 7/18; H02K 5/04; H02K 11/00; H02K 11/04; H02K 1/12; H02K 3/04

(52) U.S. Cl. CPC H02K 35/00; H02K 1/12; H02K 1/34; H02K 3/04; H02K 5/04; H02K 11/0094; H02K 11/046; H02K 7/1876

(57) ABSTRACT

A kinetic energy to electrical energy converter. The converter includes a housing defining a cavity having a circumference and covers enclosing the cavity, at least one fixedly supported perimeter magnet disposed about the circumference, at least one magnetically levitating center magnet magnetically influenced by the at least one fixedly supported magnet, positioned in the cavity and limited to substantially a two dimensional movement by the covers, and at least one coil fixedly supported with respect to the fixedly supported perimeter magnet, movements of the a least one center magnet is configured to generate an electrical current in the at least one coil.

### CROSS-REFERENCE TO RELATED APPLICATIONS

The present U.S. patent application is related to and claims the priority benefit of U.S. Provisional Patent Application Ser. No. 62/094,003, filed Dec. 18, 2014, the contents of which is hereby incorporated by reference in its entirety into this disclosure.

### TECHNICAL FIELD

The present disclosure relates generally to methods and apparatus for converting mechanical energy into electrical energy, and in particular to systems and methods for converting electromotive forces to electrical energy.

### BACKGROUND

This section introduces aspects that may help facilitate a better understanding of the disclosure. Accordingly, these statements are to be read in this light and are not to be understood as admissions about what is or is not prior art.

With the advent of wearable electronics and sensors in recent years, the ambient energy from human motion kinetic energy has become a large area of interest. The implementation of effective energy harvesting in low power wireless applications has led to long device operating lifetimes. Many different approaches have been taken for kinetic energy harvesting, the two most dominant being piezoelectric and electromagnetic.

Devices exist that convert vibration energy into electrical energy. However, such devices to date are not efficient enough to warrant widespread use, such as, for example, to power portable electronic devices or supplementally charge a battery.

For example, U.S. Pat. No. 7,009,315 discloses an apparatus for converting vibration energy into electric power which electrically converts vibration energy produced when a power system is working. The apparatus includes a bar magnet unit and a coil unit helically wound around the magnet unit. The device also uses a damping spring positioned between the magnet unit and the coil unit for holding the magnet unit at the helically neutral position of the coil unit during non-vibration and for attenuating the transmission of vibration to the coil unit during vibration. The device obtains electrical power by picking up a current flowing to the winding of the coil unit responsive to a change in the magnetic field generated when the vibration produced in the power system causes the magnet unit to move reciprocally along the helical axis of the coil unit. The device however, is constrained to movement along one or two linear axes, as illustrated for example, in FIGS. 1-4 of the '315 patent.

The use of fixed magnets to provide spring force eliminates the use of a physical spring, one of the most likely components to fail in a mechanical spring-damper system. There are also no wires attached directly to the moving mass, further eliminating another fault condition. Levitating magnet energy harvesters utilize Faraday's law of induction which states that a changing magnetic flux through a coil will result in an induced electromotive force. This EMF can be attached to a load and used to power an external system. These magnetic levitation harvesters have shown success in many different applications, ranging from wrist shaking to vehicle suspension.

One of the main difficulties with all previously presented levitating magnet energy harvesters has been their limited degrees of freedom and their high resonant frequencies. They have been limited to only one orientation for proper or ideal operation. If the harvester is tilted at an angle or rotated within the ideal orientation, harvester output can become greatly limited or eliminated. Researchers have developed devices that respond in this way as a consequence of having a free magnet that is free to move in one dimension only. Devices that have achieved rotation independence have done so without the capability of harvesting low frequency vibrations less than 10 Hz, as is needed for human walking energy harvesting. Other researchers have developed rotation independent energy harvesters but with resonant frequencies of 25 Hz and 370 Hz, respectively. Yet other researchers have developed energy harvesters with a resonant frequency of 10 Hz was developed by Moss et al., but their device is not rotation independent in its performance.

The limitation of the harvester rotation presents issues when the harvester may be worn, and the wearer is not careful to attach the device a proper rotation. Given the desire to use these harvesters in wearable electronics, it is expected that the device will rotate and be held at different angles. Clip-on devices will likely be clipped at angles and often even upside down, rendering 1-dimensional harvesters inoperable. Furthermore, while human walking has a predominant vertical acceleration force, there are also horizontal vibrations which are not utilized in these limited harvesters.

As a consequence of the constraint, the ability to generate electricity is limited to certain types of vibration and orientation. Therefore, there is an unmet need for a novel kinetic energy to electrical energy converter that is capable of taking advantage of two dimensional degrees of freedom and which can generate electrical energy based on frequencies associated with human walking.

### SUMMARY

A kinetic energy to electrical energy converter is disclosed. The converter includes a housing defining a cavity having a circumference and covers enclosing the cavity. The converter also includes at least one fixedly supported perimeter magnet disposed about the circumference. The converter further includes at least one magnetically levitating center magnet magnetically influenced by the at least one fixedly supported magnet, disposed in the cavity and limited to substantially a two dimensional movement by the covers. Furthermore, the converter includes at least one coil fixedly supported with respect to the fixedly supported perimeter magnet. Movements of the at least one center magnet is configured to generate an electrical current in the at least one coil.

A method of converting kinetic energy to electrical energy is also disclosed. The method includes providing a fixedly supported perimeter magnet disposed in a housing defining a cavity having a circumference and covers enclosing the cavity. The method also includes levitating at least one center magnet magnetically influenced by the at least one fixedly supported magnet, disposed in the cavity and limited to substantially a two dimensional movement by the covers. The method further includes providing at least one coil fixedly supported with respect to the fixedly supported perimeter magnet. Furthermore, the method includes generating an electrical current in the at least one coil in response to movements of the at least one center magnet.

### BRIEF DESCRIPTION OF THE FIGURES

FIG. 1 is a schematic a kinetic energy to electrical energy converter including a perimeter magnet and a center levitating magnet according to the present disclosure.

FIG. 2 a top schematic view of the center levitating magnet and the perimeter magnet of FIG. 1.

FIG. 3 is a top schematic view of the embodiment shown in FIG. 1 with the outer perimeter magnet oval in cross section.

FIG. 4 is a top schematic view of the embodiment shown in FIG. 1 with the center levitating magnet oval in cross section.

FIG. 5 is a perspective view of another embodiment of a kinetic energy to electrical energy converter according to the present disclosure.

FIG. 6 is a schematic view of yet another embodiment of a kinetic energy to electrical energy converter according to the present disclosure.

FIG. 7 is a cutout schematic view of the embodiment of FIG. 6.

FIG. 8 is a schematic of the kinetic energy to electrical energy converter of FIG. 6 resting upright.

FIG. 9 is a schematic of a model of the energy harvester.

FIG. 10 is another schematic of a model of the energy harvester.

FIG. 11 is a coordinate system schematic showing location and coordinates of cuboidal magnets for magnetic force calculations.

FIG. 12 is a schematic of a cylindrical coordinate system and magnet dimensions convention for cylindrical magnet magnetic field calculation.

FIG. 13 is a graph of modeled magnet force vs. magnet coordinates.

FIG. 14 is a graph of modeled magnet flux vs. magnet coordinates.

FIG. 15 shows graphs of open voltage ringdown voltages vs. time which are results of modeled and measured ring down tests conducted at two starting heights above center.

FIG. 16 is a plot of viscous damping friction coefficient (cₚ) vs. dry friction force F_{f}.

FIG. 17 shows graphs of modeled and measured ringdown tests conducting at a starting height of y=0 mm above center.

FIG. 18 shows plots of coil center y-coordinates vs. coil radius.

FIG. 19 shows graphs of model power to 1700Ω load vs. radius to perimeter magnets for an excitation frequency of 8.2 Hz.

FIG. 20 shows graphs of model power to 1700Ω load vs. radius to perimeter magnets for an excitation frequency of 9.0 Hz.

FIG. 21 shows graphs of power vs. load for both 8.2 Hz and 9.0 Hz excitations.

FIG. 22 shows bar graphs for power to 1700Ω load vs. frequency.

FIG. 23 a schematic of a rectifying circuitry that can be used with and of the kinetic energy to electrical energy converters according to the present disclosure.

FIG. 24 is a bar graph of power output to 1700Ω load vs. peak excitation acceleration.

FIG. 25 is a schematic for a convention of rotation of the harvester.

FIG. 26 is a graph of modeled resonant frequency vs. harvester rotation.

FIG. 27 is a graph of harvester's power with a 1700Ω load vs. harvester's rotation.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The levitating magnetic energy harvester presented is capable of harvesting energy from ambient vibrations in two dimensions along the harvester's plane of operation, thereby allowing the energy harvester to be rotated at any angle and will not suffer from performance degradation. The presented harvester has been tuned to an 8.2 Hz resonant frequency, making it capable of harvesting energy from the higher harmonic frequencies of human step frequencies.

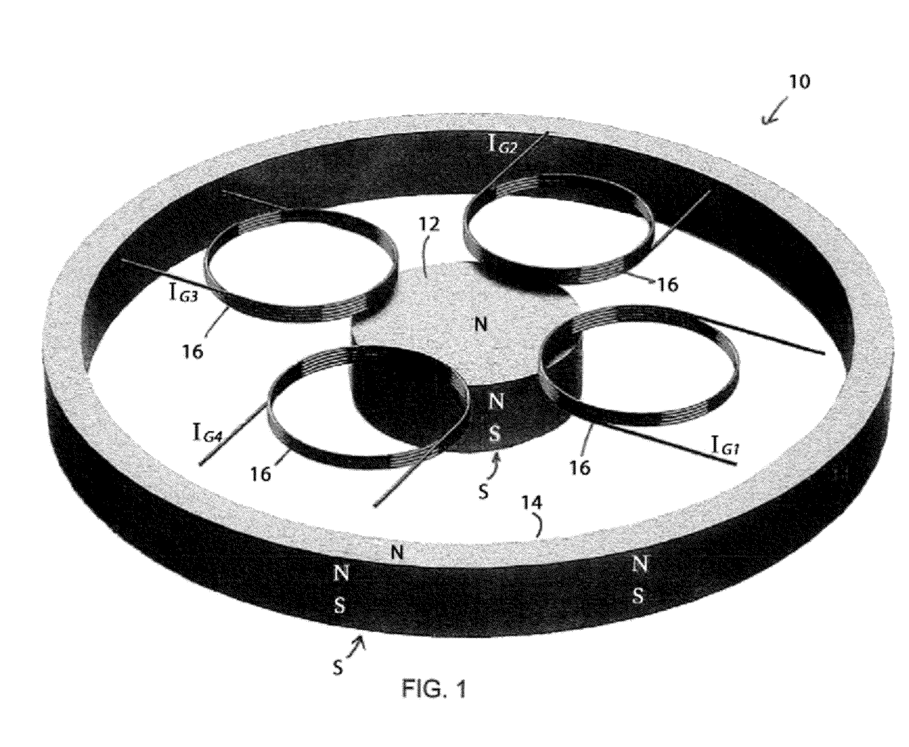

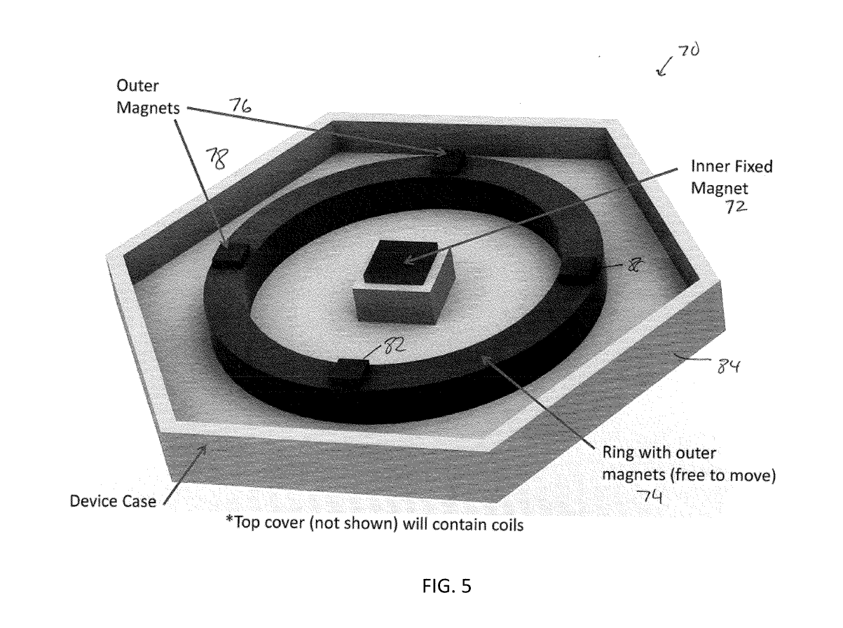

Referring to FIG. 1, a first embodiment of a kinetic energy to electrical energy converter 10 according to the present disclosure is presented. The converter 10 includes an inner levitating magnet 12, an outer fixed magnet 14, and a plurality of coils 16. While four coils 16 are shown in FIG. 1, there may suitably be other numbers of coils. For example, in an alternate embodiment, discussed below, only one coil is used. In the embodiment of FIG. 1, the levitating magnet 12 is further constrained vertically by a top cover and a bottom cover, not shown, or other means. To this end, the converter 10 may be included or be disposed in a housing, which may suitably be similar to the housing 84 of FIG. 5, described below, with a suitable top cover. A suitable lubricant may be employed with the housing.

The fixed magnet 14 in this embodiment is a ring-shaped cylindrical magnet having and south magnetic poles at top and bottom sides thereof. In an alternate embodiment, discussed below, the ring magnet can be replaced by a number of small cylindrical magnets all of which are disposed similarly, e.g., with north poles facing up and south poles facing down. The levitating magnet 12 is suspended or levitated in a position in the interior of the ring-shaped fixed magnet 14, and includes a north top pole and a south bottom pole to align in the same orientation as the north and south poles of the outer fixed magnet 14. Thus, the inner floating or levitating magnet 12 is repelled on all sides within a plane A (not shown, but one which crosses the center of the floating magnet 12 as well as the outer magnet) in which the magnets 12 and 14 reside. The housing or other constraint on vertical movement of the levitating magnet 12 prevents the levitating magnet 12 from being expelled from the plane A (not shown), and preferably from flipping.

It will be appreciated that while the opposing magnetic forces generally hold the levitating magnet 12 in the center of the ring formed by the fixed magnet 14 in plane A (not shown), movement of the converter 10, and particularly the fixed magnet 14, such as by vibration or other kinetic energy, will cause temporary displacement of the levitating magnet 12 within the ring formed by the fixed magnet 14, because the magnetic forces act as springs. After the initial movement, the magnetic forces will tend to move the levitating magnet 12 back to substantially a center position of the ring formed by the fixed magnet 14. Because the levitating magnet 12 moves with respect to the fixed magnet 14, it also moves with respect to the housing (not shown).

The coils 16 are positioned to harvest energy from movements in multiple directions. To this end, the coils are preferably in a fixed relationship with respect to either the housing (not shown), and thereby the fixed magnet 14, or with respect to the levitating magnet 12. Thus, movement of the magnet 12 with respect to the fixed magnet 14 causes a change in flux in one or more of the coils 16, which imparts a voltage across the one or more coils 16. The coils 16 can also have some ferrite core to concentrate flux and improve performance.

The device of FIG. 1 converts mechanical/kinetic energy into electrical energy to power electronics or supplementally charge a battery. The device will extend the lifetime of battery-powered electronics without requiring the device to be plugged in to a power outlet. Movement of the levitating magnet 12 is not constrained in the X and Y axes in plane A (not shown), and can harvest energy from any such movements. Any movement in the plane A (not shown) thus causes a change in magnetic flux in at least one and likely all of the coils 16. The change in magnetic flux induces a voltage, which translates to a current IG. The current IG represents a current in each of the coils 16, each coil having its own component, IG1, IG2, IG3, and IG₄.

Not only may energy be harvested from the current components IG1, IG2, IG3, and IG4, but also movement in general may be detected, and the direction of movement may he detected. For example, movement of the housing including the outer magnet 14 towards the upper left of the page will cause temporary movement of the inner magnet 12 toward the lower right coil 16, which may cause a unique induced voltage or current distribution among the coils (e.g., unique signature of currents IG1, IG2, IG3, and IG4). This unique distribution can be analyzed and the direction of movement identified.

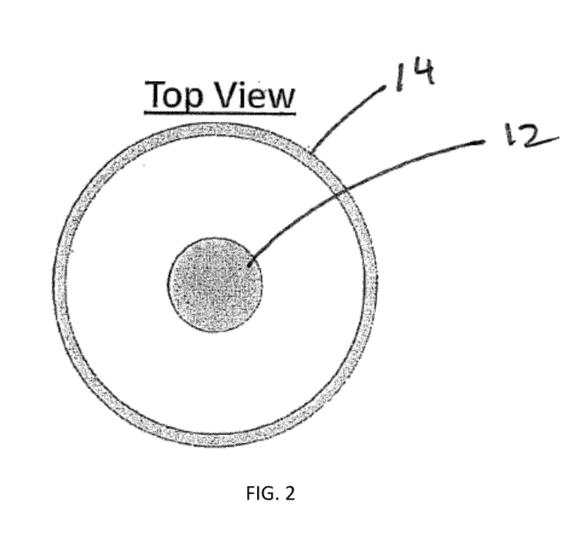

Referring to FIG. 2, a top schematic view of the two magnets 12 and 14 apart from the coils, directly normal to the plane A (not shown) is provided. The device of FIGS. 1 and 2, therefore, convert vibration energy into electrical energy to power electronics or charge a battery. The vibration can be from a machine, building, human movement, etc. The device can harvest energy from any in-plane movements (2 dimensions). Potential applications include sensor nodes and portable electronics. The generalized features of the embodiments depicted thus far is that a cylindrical magnet (levitating magnet 12) is inside a larger ring magnet (fixed magnet 14, or a plurality of smaller magnets similarly situated with respect to their nodes around a ring). The coils 16 (or alternatively only one coil 16) are disposed such that any relative movement between the levitating magnet 12 and fixed magnet 14 induces voltages and/or currents. It should be appreciated that either magnet (i.e., fixed magnet 14 or levitating magnet 12) can be the ‘fixed’ magnet, where the other one is free to move when an excitation is applied in any in-plane direction. The magnets arranged so that they have repulsive forces between each other.

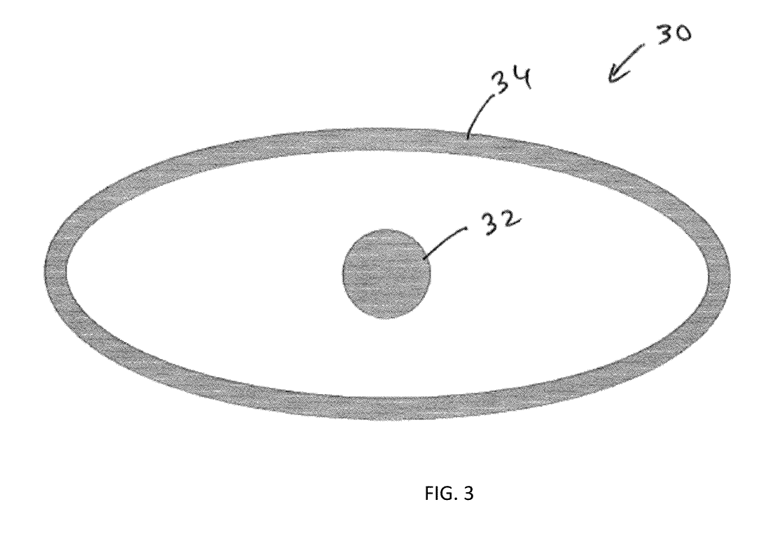

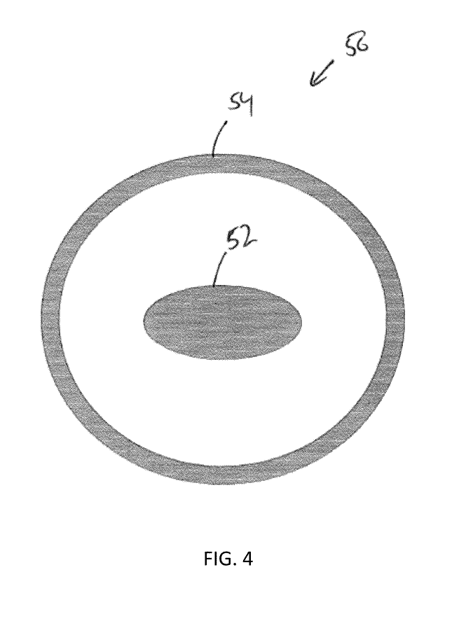

FIGS. 3 and 4 show schematic diagrams of magnetic arrangements that may be used in alternative embodiments of kinetic energy to electrical energy converter 30, 50 that may he used a kinetic energy to electrical energy converter according to the present disclosure. The coils have been omitted, but may suitably include any appropriate number of coils as shown in FIG. 1, arranged in the same manner.

In the embodiment of FIG. 3, the outer fixed magnet 34 is oval in cross section (but otherwise similar (to the outer fixed magnet 14 of FIG. 1). The inner magnet 32 is cylindrical and similar to the levitating magnet 12 of FIG. 1. In the embodiment of FIG. 4, the outer fixed magnet 54 is cylindrical similar to the outer magnet 14 of FIG. 1. The inner levitating magnet 32 is oval in cross section but otherwise similar to the levitating magnet 12 of FIG. 1. An advantage of these embodiments is that they would have different resonant frequencies in different directions. This feature may be used, for example, for detecting direction of the movement. Each resonant frequency component is representative of a movement component in the respective direction.

FIG. 5 shows yet another embodiment of a kinetic energy to electrical energy converter 70 according to the present disclosure. The converter 70 includes an inner fixed magnet 72, an outer floating ring 74 and a plurality of individual magnets 76, 78, 80, 82 secured to the flowing ring 74. The device also includes one or more coils in the area of the magnetic field and/or flux of the magnets 72 (and one or more of magnets 76, 78, 80 and 82). The ring 74 may be nonmagnetic. The ring 74 (and magnets 76, 78, 80 and 82 thereon) are free to move in a housing 84, while the inner fixed magnet 72 is fixedly mounted to the housing 84. Coils, not shown, but similar to those of FIG. 1, are disposed on a top cover (not shown) to harvest the energy. The housing 84 and the top cover (not shown) may suitably be constructed of material to shield the magnetic fields. A single coil may alternatively be disposed about the fixed magnet 72.

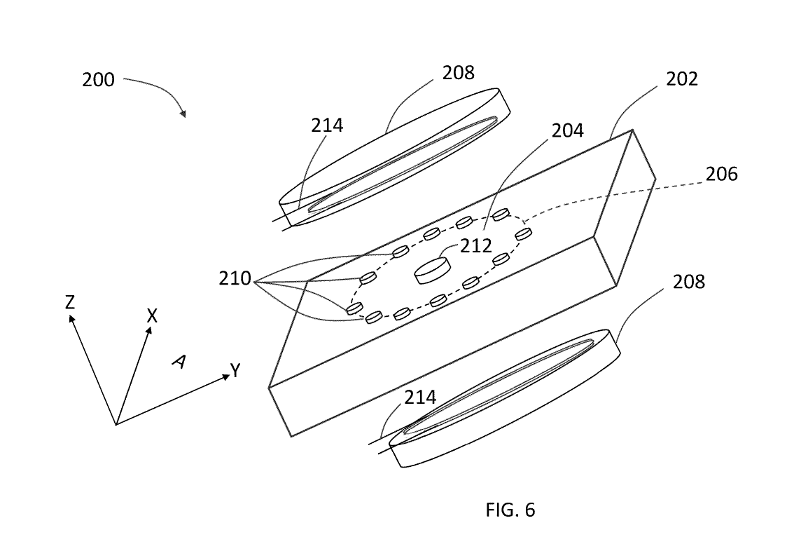

In any of the above embodiments of FIGS. 1-4, the solid ring magnets can be replaced with multiple discrete magnets (similar to FIG. 5), as shown in FIG. 6 described below. Magnets can be any shape and are not limited to cylindrical, ring, or block magnets. Circuit components could also be added to the moving magnet to increase the mass of the moving magnet. The coils can have a ferrite core to concentrate flux and improve performance magnetic shielding material may be used to confine the magnetic flux.

Referring to FIG. 6, yet another embodiment of the kinetic energy to electrical energy converter according to the present disclosure is shown. The kinetic energy to electrical energy converter 200 includes a housing 202, defining a cavity 204 about a circumference 206. Two caps 208 are provided to allow movement of moveable components to X-Y direction (shown as in movement along plane A) but to restrict movement in the Z direction. About the circumference 206, are perimeter magnets 210, fixedly supported with respect to the housing 202. Substantially centrally positioned within the circumference is a levitating center magnet 212. In one or both caps 208 are also provided one or more coils 214.

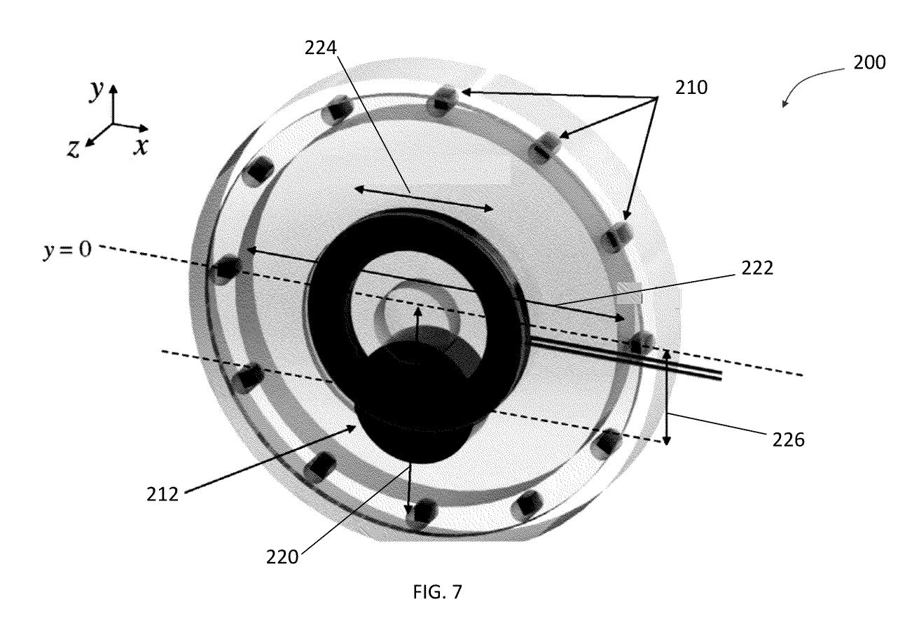

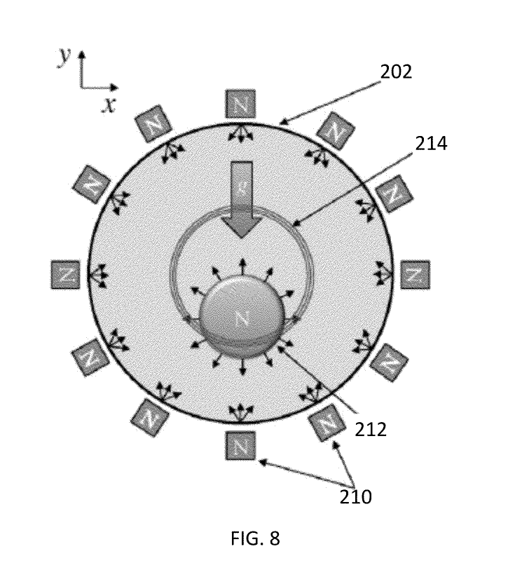

A schematic view of the kinetic energy to electrical energy converter is shown in FIG. 7. A free moving, axially magnetized disk magnet (i.e., the levitating center magnet 212) lies on a 2-dimensional plane with freedom of radial movement. A circular sidewall (i.e., circumference 206 as shown in FIG. 6) in the housing 202 is constructed to constrain the boundary for the center levitating magnet 212 and hold fixed perimeter magnets 210. The fixed perimeter magnets 210 are stationary axially magnetized cuboidal magnets that are distributed around the circumference of the sidewall to provide a spring force which returns the free levitating magnet 212 to an equilibrium position following perturbation. While the casing can be machined out of a wide range of materials, in this device it is machined out of TEFLON for its low coefficient of friction and for its softness which makes for ease of fabrication. With the kinetic energy to electrical energy converter 200 (hereinafter also referred to as energy harvester or simply harvester) resting upright such that the force of gravity is towards the bottom of the harvester, the levitating magnet 212 (also referred herein as the free moving center magnet) will be offset from the center of the harvester, as shown in FIG. 8 (a schematic of the kinetic energy to electrical energy converter 200 resting upright).

Many factors are involved in the design of the energy harvester dimensions and configuration. Due to the desire for full 2-dimensional functionality, symmetry in a circular design is preferential. A sufficient number of perimeter magnets are then required to ensure minimal variation in harvester output due to rotation. Minimal has been defined as a maximum 0.5 Hz variation in resonant frequency with harvester rotation. The magnet force also needs to be sufficient such that the center magnet does not hit sidewalls at appreciable accelerations.

One coil of N turns is z-positioned above the free moving center magnet on one side of the energy harvester. Due to Faraday's law of induction, the changing magnetic flux through this coil will result in an induced EMF. The coil output may then be attached to a load and electrical energy may be harvested from the motion of the center magnet. The inductance of the coil can be roughly estimated using air core coil inductance calculators to be about 50 μH. With a frequency of 10 Hz, this is an impedance of 3Ω, or about less than 1% of the coil resistance.

A low resonant frequency is desired such that the harvester can be used in human walking kinetic energy harvesting applications. Dominant step frequency of human walking falls at around 2-3 Hz. Due to the inherently inverse relationship between resonant frequency and harvester size, obtaining a resonant frequency in the 2-3 Hz range would require a large harvester, excluding it from wearable electronics applications. For this reason, wearable energy harvesters to date are designed to have a resonant frequency matching one of the higher harmonics of the dominant step frequencies, around 6-8 Hz.

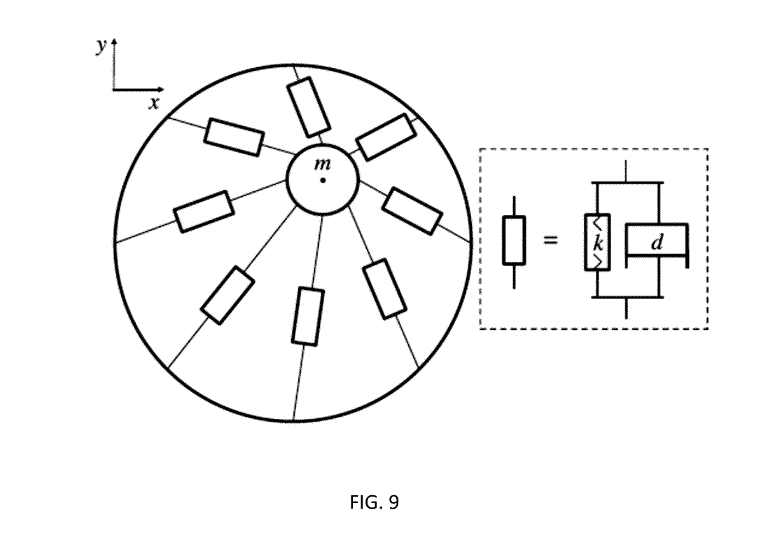

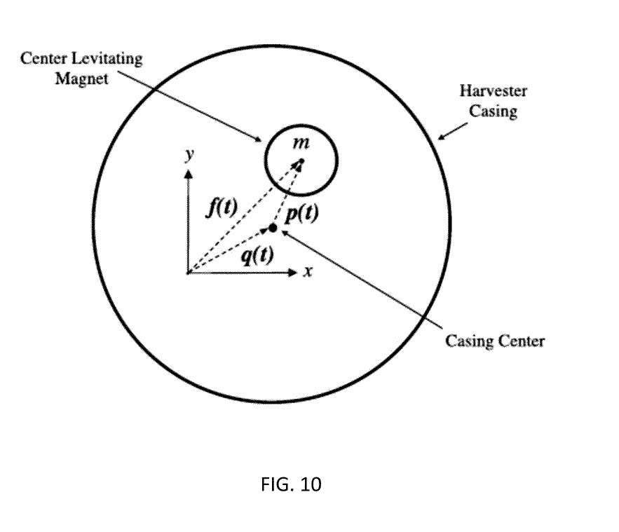

The energy harvester may be modeled mechanically as a mass-spring-damper system, as illustrated in FIG. 9 (a schematic of a model of the energy harvester). An external source displaces the housing by q(t), causing a mass m, attached to springs k and dampers d, to displace by p(t) relative to the housing. Due to the 2-dimensional nature of the harvester, q(t) and p(t) can be in any two dimensions. The convention in this paper will be with directions x and y as shown in FIG. 10 (another schematic of a model of the energy harvester). The parameters k and d are simplifications, since the perimeter magnet forces are nonlinear and the damping forces incorporate mechanical, aerodynamical, and electromagnetic losses.

As shown in FIGS. 7-10, under vertical excitation, vibration always occurs in the y direction, which is also the direction of gravity. Therefore, further analysis can assume that all motion will occur in the y direction only, and 1-dimensional variables can be used. The functions f(t), q(t), and p(t) are then the y direction components of the respective vectors. With this simplification in mind, a general expression for y directional motion for the free moving center magnet of mass m is given by

$${F}_{mag} ( p ( t ) ) - {F}_{f} \frac{\vert {p}^{′} ( t ) \vert}{{p}^{′} ( t )} - {c}_{p} {p}^{′} ( t ) - {F}_{em} ( p ( t ) , {p}^{′} ( t ) ) - m {q}^{″} ( t ) - m g = m {p}^{″} ( t ) \qquad ( 2 )$$

wherein, F_{mag} is the fixed magnet force,
F_{f} is the dry friction force,
Cₚ is damping coefficient,
Fₑₘ is the electromagnetic damping force. The relative displacement within the harvester p(t) is the value of interest since it determines the change of flux through the coil, and therefore the voltage produced. The fixed magnet force F_{mag} is a nonlinear function of magnet position and is calculated analytically below. The dry friction force F_{f} is constant and always acts against motion. The aerodynamic viscous damping acts against motion and is the product of cₚ and magnet speed.

The electromagnetic damping force Fₑₘ is the force that acts to resist the magnet's motion near the coil. It is caused by the magnetic field that the coil generates as current is induced by the changing flux of the moving magnet. This force is responsible for the energy from the magnet's motion that is being harvested. The instantaneous power delivered to the coil and load as a function of coil open circuit voltage V_{oc}, coil flux Φ_{B}, load resistance R_{load}, and coil resistance R_{coil} is

$$\begin{matrix}{P}_{out} = \frac{{V}_{oc}^{2}}{{R}_{load} + {R}_{coil}} \\ = \frac{{( \frac{d {Φ}_{B}}{d t} )}^{2}}{{R}_{load} + {R}_{coil}} \\ = \frac{{( \frac{d {Φ}_{B}}{d p} \frac{d p}{d t} )}^{2}}{{R}_{load} + {R}_{coil}}\end{matrix} \qquad ( 2 a )$$

The instantaneous power input from Fₑₘ acting against the magnet's motion is

Pᵢₙ=Fₑₘp′(t) (2b)

By conserving energy,

$$\begin{matrix}\begin{matrix}{P}_{i n} = {P}_{out} ⇒ {F}_{em} {p}^{′} ( t ) \\ = \frac{{( \frac{d {Φ}_{B}}{d p} \frac{d p}{d t} )}^{2}}{{R}_{load} + {R}_{coil}}\end{matrix} & ( 2 c ) \\ \begin{matrix}{F}_{em} = \frac{{V}_{oc}^{2}}{{p}^{′} ( t ) ( {R}_{load} + {R}_{coil} )} \\ = \frac{{( \frac{d {Φ}_{B}}{d p} )}^{2} {p}^{′} ( t )}{{R}_{load} + {R}_{coil}}\end{matrix} & ( 2 d )\end{matrix}$$

The derivative dΦ_{B}/dₚ is the displacement-derivative of magnetic flux through the coil, a parameter calculated in Section 3.3. It depends on p(t) and is a function determined by the coil placement and magnet characteristics (strength and dimensions). Therefore, Fₑₘ is a function of p(t) and p′(t) as shown in Eq. 2. The quantity −mq″(t) is the pseudo-force felt by the magnet due to the acceleration of the casing. Finally, −mg is the force of gravity.

The fixed perimeter cuboidal magnets and the center free moving disk magnet impart a repellant force upon one another. Many different methods and solutions for determining the force between different types and shapes of permanent magnets exist. Some of these methods are semi-analytical or completely numerical and could be used interchangeably, but an analytical solution was sought after in this work. The analytical solution exists for the force between cuboidal magnets. For this reason, the center magnet was modeled as a cuboidal magnet with volume equal to that of the cylindrical magnet used in measurements. This simplification introduces error, but good agreement with the model and experimental measurements shows that the error is minimal.

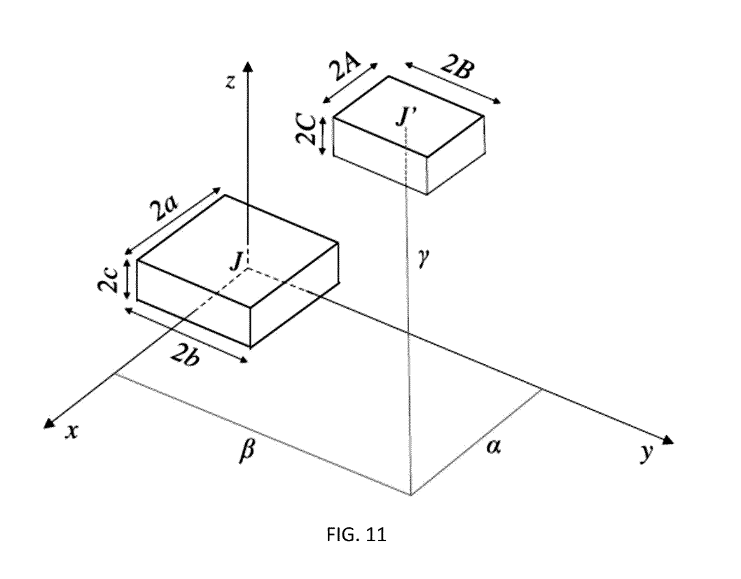

The force on the center magnet due to fixed perimeter mag-nets was calculated iteratively and then summed. In each case, the center free moving magnet and the fixed perimeter magnet were modeled as a pair of “magnetically charged” parallel plates with σ and σ′ charge, respectively. Since both magnets are the same grade (N42 neodymium), σ=σ′. The coordinates for the pair of cuboidal magnets is demonstrated in FIG. 11 (a coordinate system schematic showing location and coordinates of cuboidal magnets for magnetic force calculations). The first magnet sits centered at the origin with dimensions of 2a×2b×2c. The second magnet is centered in space at (α, β, γ) with dimensions of 2A×2B×2C. The magnets are both axially S-N magnetized in the z direction to produce repulsion, which is represented by the fact that σ and σ′ have the same sign. The interaction energy between the two sets of parallel charged plates is found by using.

$$W = {\int }_{- a}^{+ a} d x {\int }_{- b}^{+ b} d y {\int }_{- A}^{+ A} d X {\int }_{- B}^{+ B} d Y \frac{{σσ}^{′}}{4 π {μ}_{0} r} \qquad ( 3 a )$$

Where μ₀ is the permeability of free space.

r=\sqrt{(α+X−x)²+(β+Y−y)²+y²} (3b)

The pair of magnets have magnetizations J and J′, and they are related to the magnetic charges densities by

σ=\vec{J}·\vec{n} (4a)

Assuming that \vec{J} and \vec{n} are parallel leaves

σ=J and σ′=J′ (4b)

The gradient of the interaction energy is taken to determine the force between the cuboidal magnets. This expression is given by

$$\begin{matrix}{F}^{->} = - ∇ W \\ = \frac{J {J}^{′}}{4 π {μ}_{0}} {\sum }_{\{ i , j , k , l , p , q \} = {\{ 0 , 1 \}}^{6}} {( - 1 )}^{i + j + k + l + p + q} φ ( u , v , w , r )\end{matrix} \qquad ( 5 )$$

for force vector components Fₓ, F_{y}, and F_{z}, respectively:

$$\begin{matrix}{φ}_{x} = \frac{1}{2} ( {v}^{2} - {w}^{2} ) ln ( r - u ) + u v ln ( r - v ) + v w arctan \frac{u v}{r w} + \frac{1}{2} r u & ( 6 a ) \\ {φ}_{y} = \frac{1}{2} ( {u}^{2} - {w}^{2} ) ln ( r - v ) + u v ln ( r - u ) + u w arctan \frac{u v}{r w} + \frac{1}{2} r v & ( 6 b ) \\ {φ}_{z} = - u w ln ( r - u ) - v w ln ( r - v ) + u v arctan \frac{u v}{r w} - r w & ( 6 c )\end{matrix}$$

with

u(i,j)=α+(−1)^{j}A−(−1)ⁱa (7a)

v(k,l)=β+(−1)^{l}B−(−1)^{k}b (7b)

w(p,q)=γ+(−1)^{q}C−(−1)^{p}c (7c)

r(u,v,w)=\sqrt{u²+v²+w²} (7d)

For this analysis, only the y direction force F_{y} is needed due to symmetry. This force is calculated at discrete y coordinates reachable by the free moving center magnet (x=0). This is done for each perimeter magnet and the F_{y} forces are then summed, giving the total vertical force on the center magnet as a function of y coordinate. Given that all the magnets are centered on the same x-y plane, and no z displacement is possible, F_{z} is zero.

When the device is held upright, gravity pulls the center magnet to an equilibrium point y0 where m_{g}=F_{y}. At this point, the displacement-derivative of F_{y} can approximate the resonant frequency of the center magnet by Eq. (8b).

$$\begin{matrix}{k}_{equilibrium} = \frac{d {F}_{y}}{d y} {\vert}_{y = {y}_{0}} & 8 ( a ) \\ {f}_{res} = \frac{1}{2 π} \sqrt{\frac{{k}_{equilibrium}}{m}} & 8 ( b )\end{matrix}$$

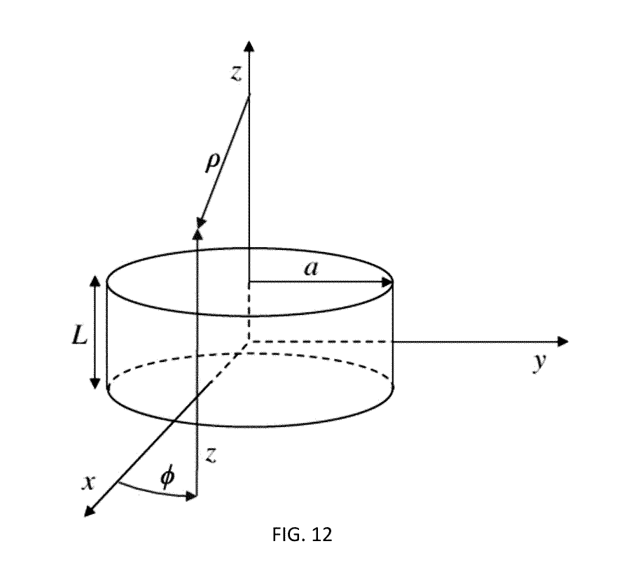

A cylindrical magnet with axial magnetization may be modeled as a cylindrical coil of equal diameter and height with azimuthal surface current equal to J, and its magnetic field can then be deter-mined analytically. The coordinate system for the cylindrical magnetic field calculations is shown in FIG. 12 (a schematic of a cylindrical coordinate system and magnet dimensions convention for cylindrical magnet magnetic field calculation). The magnet has radius a and thickness L. Due to the symmetric nature of the cylindrical magnet around the origin, the magnetic field strength will vary only with ρ and z. The parameter φ does not affect the magnetic field strength.

The magnet moves at a z-offset beneath the coil. As the change in magnetic field through the coil results in the induced EMF, the only magnetic field component of interest is the B_{z}. B runs tangential to the coil surface and B_{φ} is zero. The expression for B_{z} above the magnet is split into two regions of interest; the region above the magnet within the radius of the magnet, and the region above the magnet outside the radius of the magnet. These are respectively given by

$$\begin{matrix}\frac{{B}_{z} ( ρ < a , z > L )}{{B}_{∞}} = - {\sum }_{n = 0}^{∞} \frac{{( - 1 )}^{n} ( 2 n + 1 ) !}{{2}^{2 n + 2} {( n ! )}^{2}} \times [ {( \frac{a}{2} )}^{2} {( \frac{ρ}{z} )}^{2 n} F ( n + 1 , n + \frac{3}{2} ; 2 ; - \frac{{a}^{2}}{{z}^{2}} ) - {( \frac{a}{z - L} )}^{2} {( \frac{ρ}{z - L} )}^{2 n} F ( n + 1 , n + \frac{3}{2} ; 2 ; - \frac{{a}^{2}}{{( z - L )}^{2}} ) ] & ( 9 a ) \\ \frac{{B}_{z} ( ρ < a , z > L )}{{B}_{∞}} = - {\sum }_{n = 0}^{∞} \frac{{( - 1 )}^{n} ( 2 n + 1 ) !}{{2}^{2 n + 2} n ! ( n + 1 ) !} \times [ {( \frac{a}{2} )}^{2 n + 2} F ( n + 1 , n + \frac{3}{2} ; 1 ; - \frac{{ρ}^{2}}{{z}^{2}} ) - {( \frac{a}{z - L} )}^{2 n + 2} F ( n + 1 , n + \frac{3}{2} ; 1 ; - \frac{{ρ}^{2}}{{( z - L )}^{2}} ) ] & ( 9 b )\end{matrix}$$

where F(a; b; c; d) is the Gaussian hypergeometric function, and B_{∞} is the B-field intensity that would be inside a solenoid of equal diameter and surface current, but of infinite length.

B_{∞}=μ₀J (10)

In computer modeling, the summations are finite, and an adequate upper bound for n must be used. Such an adequate value can be determined by comparing the discontinuous values of B_{z}/B_{∞} for both expressions at their joining point p=a. The discrepancy is large with small n upper bounds less than 5 (at n=5, 2.3% discrepancy). An n upper bound of 10 is sufficient to close this discrepancy to less than 0.1%. The simulation in this work uses an n upper bound of 50, to ensure accuracy with reasonable simulation times. Once the magnetic field z-component B_{z} can be known for any point above the magnet, where the coil will be, then the magnetic flux φ_{B} can be calculated with

Φ_{B}=∫∫_{S}BᵣdA (11)

where S is the total surface enclosed by each loop of the coil. This general form of the equation accounts for the multiple loops of wire, and is necessary since B_{z} will vary along the different heights and diameters of the turns of the coil. The magnetic flux φ_{B} will be a function of magnet position p(t), and the coil voltage will be the derivative

$$V = \frac{d {Φ}_{B}}{d t} \qquad ( 12 )$$

This voltage will be distributed across the coil resistance and the load resistance in series.

The radius of the coil in the presented harvester was chosen so that the edge of the coil is at the same level as the equilibrium point of the center magnet. This is due to there being maximum change in flux through the coil when the magnet is crossing the coil edge. Therefore, the inner and outer radii of the coil were chosen to be 8.5 mm and 12.5 mm, respectively. With the coordinate system shown in FIG. 7, the coil extends in the z direction from 1.0 mm to 2.5 mm past the end of the center magnet, and contains 1200 turns of 42 AWG magnet wire.

The magnetic flux through the coil was calculated numerically. First, B_{z} was calculated at discrete values as a function of and z. Then, the magnetic flux φ_{B} through the coil's 1200 turns of varying radii and heights was found by numerical integration to approximate Eq. (11), as a function of the y coordinate of the center magnet.

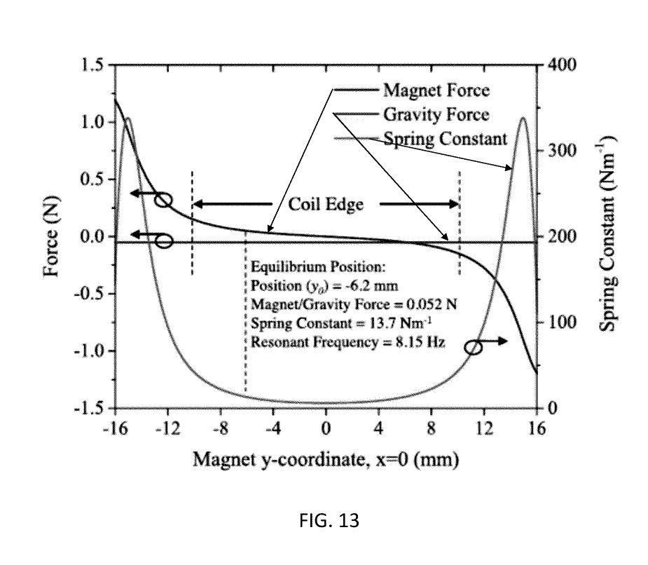

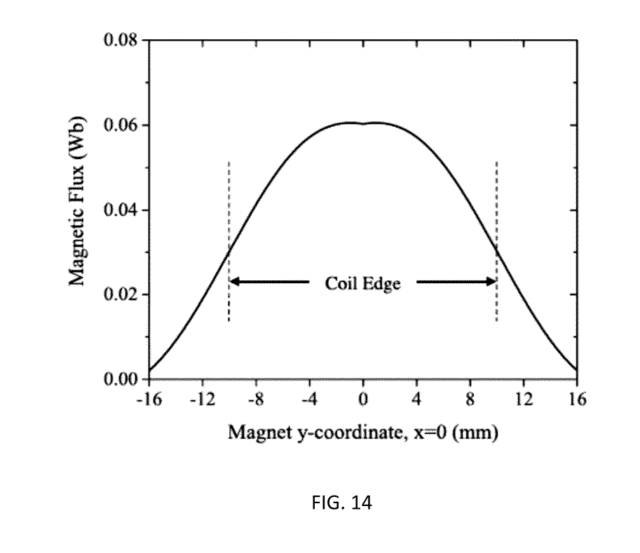

A MATLAB/SIMULINK model has been developed to aid in optimizing energy harvester design. The model implements the equations in the previous subsections to simulate the center magnet's motion in response to an external excitation of choice. This in turn allows the model to simulate power delivery to a load of choice. The model for the presented harvester was constructed using the derived parameters shown in FIG. 13 (a graph of modeled magnet force vs. magnet coordinates) and FIG. 14 (a graph of modeled magnet flux vs. magnet coordinates).

The equilibrium point y₀ is determined in the model to be at y=−6.2 mm. Using Eq. (8b), this yields a resonant frequency of 8.15 Hz.

A Simulink time step model simulates the energy harvester operation by solving Eqs. (2), (2d), and (12). Through this time step model, several values are calculated. Of importance is the induced voltage in the coil, named hereafter as the open circuit voltage,

$${V}_{oc} = \frac{d {Φ}_{B}}{d t} \qquad ( 13 )$$

where φ_{B} is the total flux through the coil (the number of turns has been accounted for). From here, load voltage can be determined with coil resistance R_{coil}, and load resistance R_{load} by

$${V}_{load} = {V}_{oc} \frac{{R}_{load}}{{R}_{load} + {R}_{coil}} \qquad ( 14 )$$

The instantaneous and average power delivered to the load, respectively, are

$$\begin{matrix}P = \frac{{V}_{load}^{2}}{{R}_{load}} & ( 15 a ) \\ ( P ) = \frac{( {V}_{load}^{2} )}{{R}_{load}} & ( 15 b )\end{matrix}$$

The model finds the average power delivered to the load for the given parameters of the simulation, such as vibration profile, center magnet starting position, and harvester rotation.

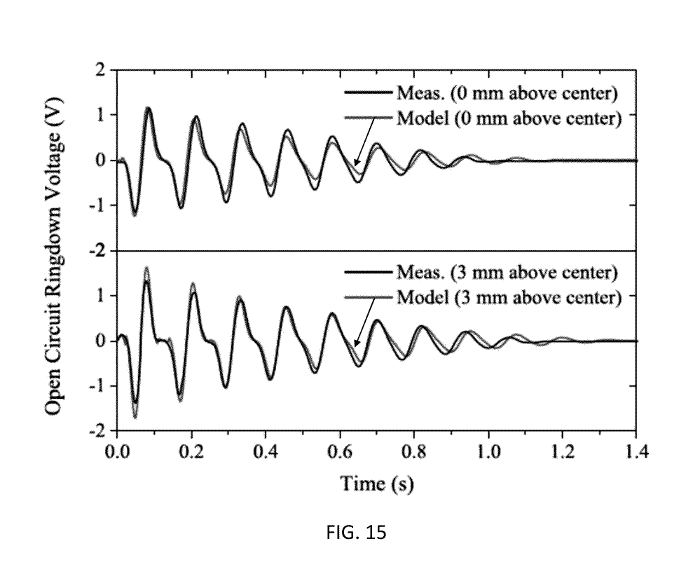

An initial modeling test to perform is the ring down test. With the harvester held upright and with no external excitation, the center magnet is brought to a specific height, and then quickly released. The result is a damped, undriven oscillator. The test is shown in FIG. 15 (graphs of open voltage ringdown voltages vs. time which are results of modeled and measured ring down tests conducted at two starting heights above center), performed at starting heights of y=0, and y=3 mm above center. This test becomes useful in experimentally determining the unknown frictional parameters from Eq. (2), F_{f} and cₚ.

To determine the best combination of F_{f} and cₚ, one can calculate the error between modeled and measured results of the discrete data sets of the two ringdown tests above.

$$error = {\sum }_{0 mmtest} {( {V}_{meas} - {V}_{mod} )}^{2} + {\sum }_{3 mmtest} {( {V}_{meas} - {V}_{mod} )}^{2} \qquad ( 16 )$$

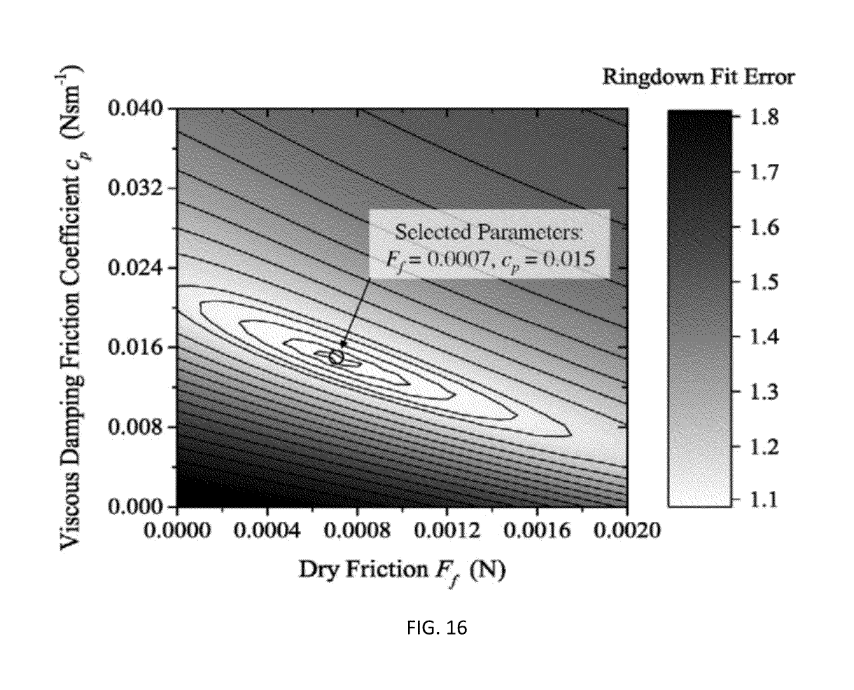

The logarithm is taken twice in order to facilitate locating the minimum value of error on a contour plot error as a function of F_{f} and cₚ is shown in FIG. 16 (which is a plot of viscous damping friction coefficient (cₚ) vs. dry friction force F_{f}) and it shows that the best model-measurement agreement in the ringdown test is found with F_{f}=0.0007 N, and cₚ=0.015 Ns m⁻¹.

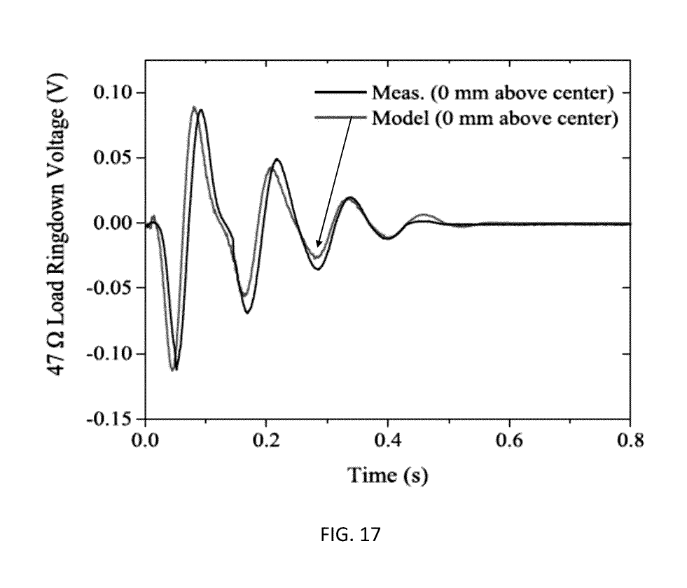

A look at the good agreement in FIG. 17 (which are graphs of modeled and measured ringdown tests conducting at a starting height of y=0 mm above center) of the ringdown test for the case of a 47Ω load shows an example of model validation. Modeling with a light load demonstrates that the model accurately simulates the electromagnetic damping force Fₑₘ from Eq. (2d) which equals zero in the open circuit case.

With a versatile model in place, a few important optimization simulations can be produced. These simulations provide an important insight in what direction to take towards an optimal design, while reducing the need for excessive prototyping. The following simulations rely on a couple important parameters that are both modeled and measured, and are shown in Section 4. These include the optimum load for power transfer, 1700Ω, and the optimum excitation frequency, 8.2 Hz. It should also be noted that while the model is capable of simulating with a pure sinusoidal external excitation, better agreement was observed by inputting the accelerometer waveform from the shaker that was used to con-duct measurements on the presented harvester. These simulations therefore use the accelerometer data from said shaker as excitation input. The following examples show some of the optimization capabilities that the model can realize.

Using the presented harvester's dimensions and perimeter mag-net count of 12, a simulation to optimize the diameter and location of the coil can be generated. This simulation assumes the number of turns in the coil remains 1200, and that the coil is only moved up or down, along the y axis, on the harvester casing. Additionally, this optimization is while the harvester is under an 8.2 Hz, 0.2 g excitation. Different optimizations may be reached for different excitations.

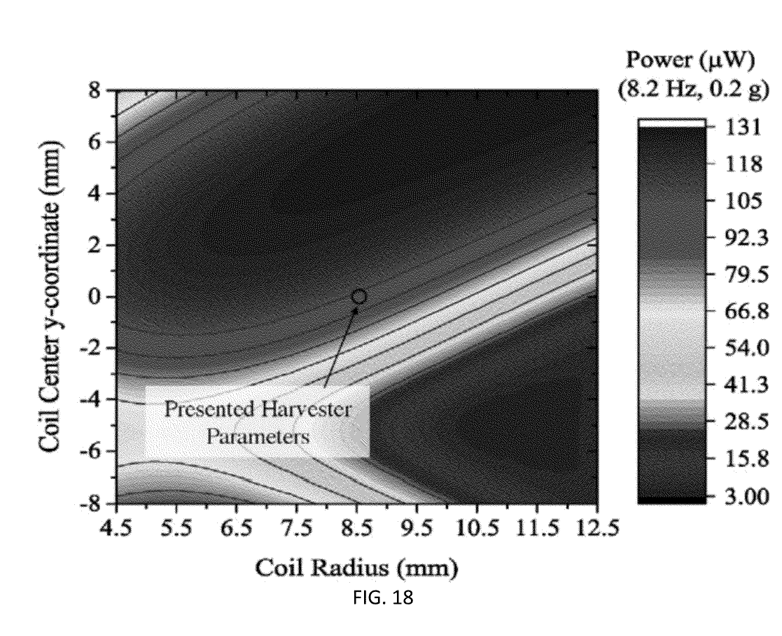

The simulation from FIG. 18 (which are plots of coil center y-coordinates vs. coil radius) shows that optimizing the design would involve increasing the coil diameter as well as raising the location of the coil on the casing. Optimal power output is modeled to be over 120 μW.

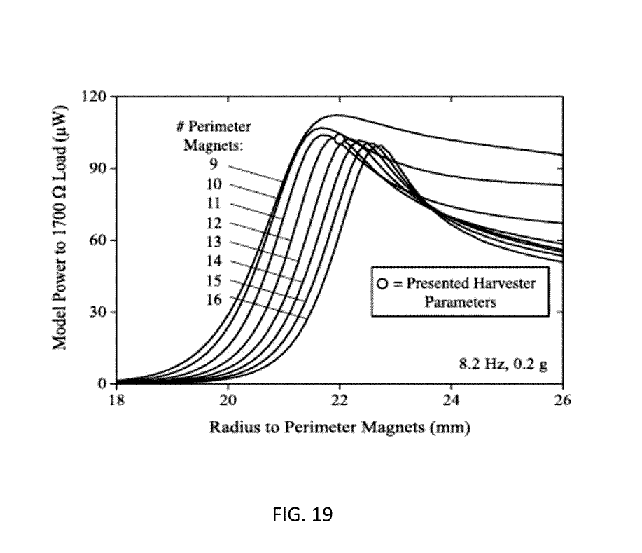

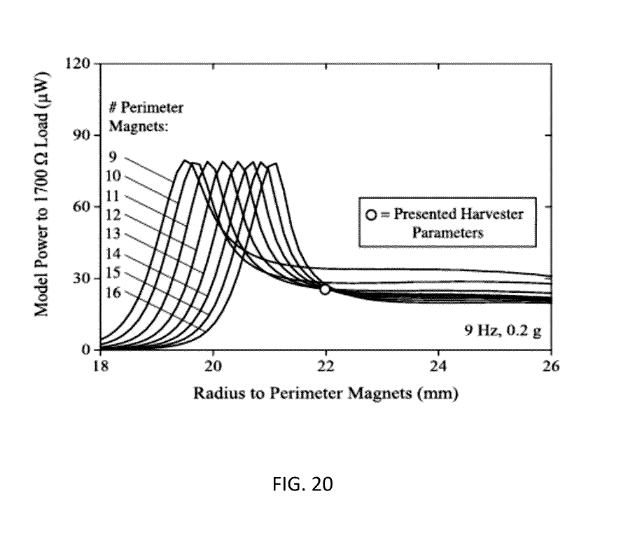

If the coil is instead held constant, so that its parameters are as those of the presented harvester, then a simulation to optimize the dimensions of the harvester, and the number of perimeter magnets can be generated. This is shown for an excitation frequency of 8.2 Hz in FIG. 19 (which are graphs of model power to 1700Ω load vs. radius to perimeter magnets for an excitation frequency of 8.2 Hz). This simulation is more so used to tune the harvester to a specific frequency. As such, FIG. 20 (which are graphs of model power to 1700Ω load vs. radius to perimeter magnets for an excitation frequency of 9.0 Hz) shows what parameters would instead be optimal if a frequency of 9.0 Hz was desired, instead of 8.2 Hz. This analysis depends on using a constant load, so the optimal load for the presented harvester (1700Ω) is used. If say an energy harvester tuned to 9 Hz were to be built using this tool, then the optimum load would have to be determined again.

The model can be further configured to optimize more than two parameters at a time, however, figures can't clearly demonstrate this. Mainly, the optimization techniques shown are to display the versatile nature of the model, and that an optimization process can be created to design a device that is best suited for a particular purpose. This is done by identifying a few desired characteristics for the device, such as resonant frequency, size constraint, optimum load size, etc. Then, an optimization model can be used to determine the remaining design parameters, such as number of perimeter magnets, radius to perimeter magnets, coil location and size, even center and perimeter magnet strength and mass.

A few tests are performed using the presented harvester in order to determine its power output, as well as its agreement with the model for model validation. A load sweep test determines the optimum load for maximum power transfer when the harvester is subjected to an external excitation of 8.2 Hz and 9.0 Hz, with a maximum acceleration of 0.1 g.

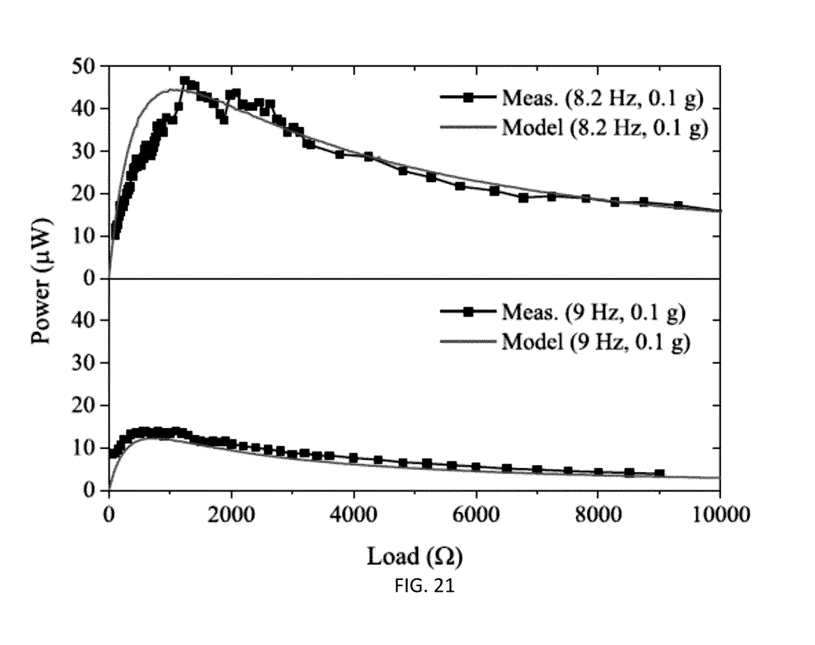

The test, results of which are shown in FIG. 21 (which are graphs of power vs. load for both 8.2 Hz and 9.0 Hz excitations), determines that a load of 1700Ω is optimum for maximum power transfer. It also shows that 8.2 Hz excitation near the modeled resonant frequency does indeed out-perform the 9.0 Hz excitation. Also, the agreement in both scenarios shows that the model is valid for this variation in external excitation.

A frequency sweep determines what frequency excitation leads to the greatest power delivery to the load. This test is done at 0.1 g and 0.2 g maximum acceleration to introduce measurement variation.

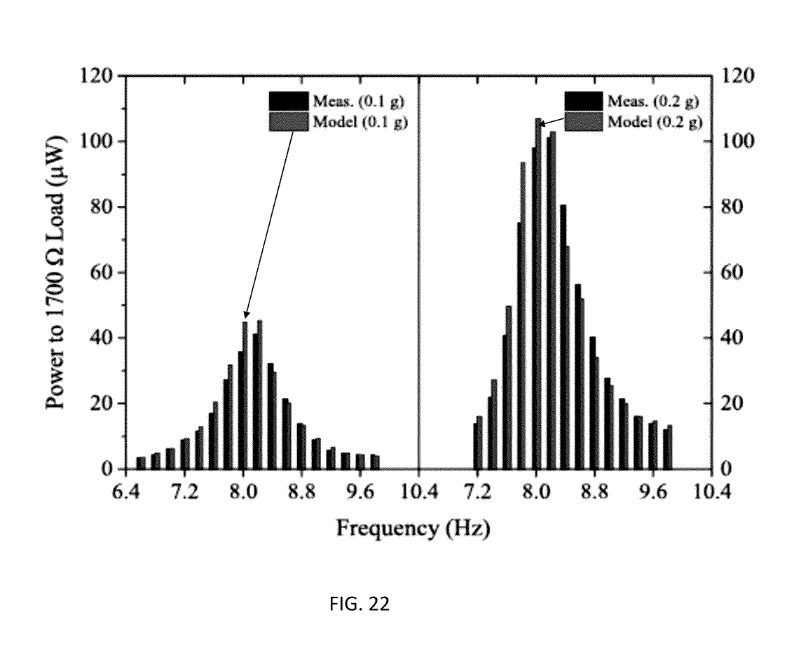

The test, results of which are shown in FIG. 21 (which are graphs of power vs. load) and FIG. 22 (which shows bar graphs for power to 1700Ω load vs. frequency), show that that the optimum frequency, 8.2 Hz, matches the resonant frequency, 8.15 Hz, predicted by the model as shown in FIG. 13. This test also serves to produce the power rating for the device. This is stated to be 41.0 μW and 101 μW, at input excitations of 8.2 Hz with 0.1 g and 0.2 g accelerations, respectively.

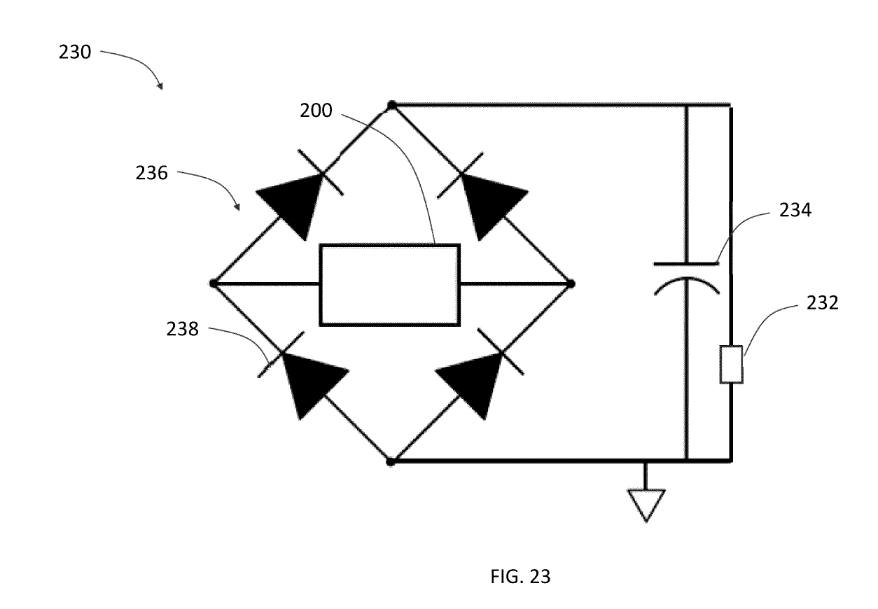

The tests were performed with a rectifying circuitry 230 that is shown in FIG. 23. The circuitry includes a load 232, a storage device 234, and a rectification bridge 236 including a plurality of diodes 238. The harvester 200 is positioned in the bridge 236 are shown in FIG. 23.

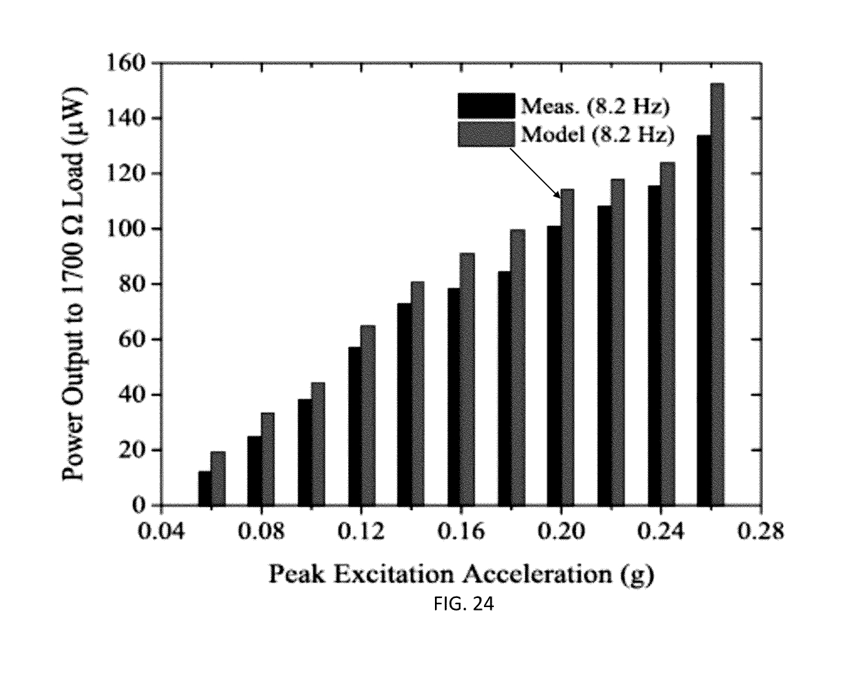

Lastly, an acceleration sweep test is shown in FIG. 24 (which is a bar graph of power output to 1700Ω load vs. peak excitation acceleration). This test reveals the positive correlation between maximum excitation acceleration and power output. The frequency and acceleration sweeps again serve to validate the model by demonstrating good model-measurement agreement, though the model does slightly overestimate power output in these tests. However, this validation is necessary in order to use the model for design optimization as discussed above.

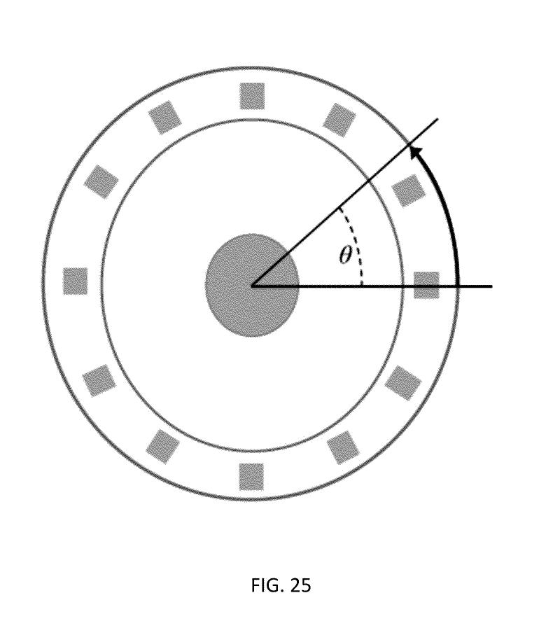

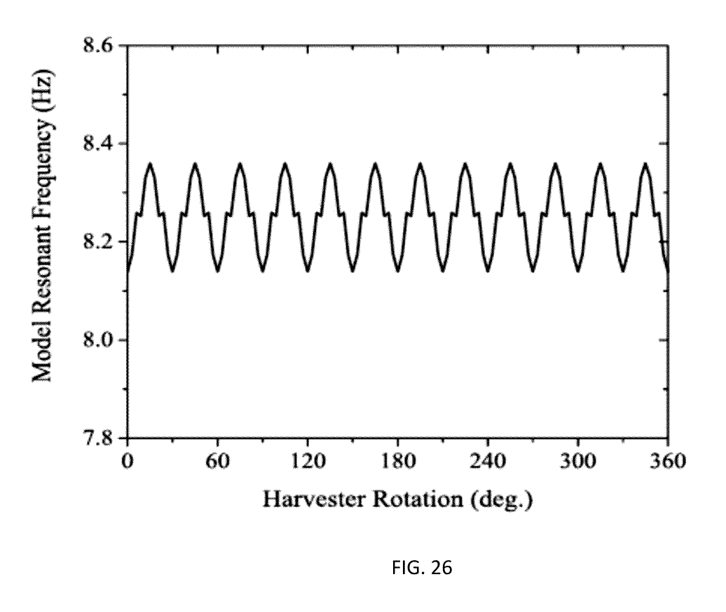

The harvester's rotation independence to power output, is also demonstrated. While the harvester exhibits nearly uniform response as a function of rotation in the x-y plane, the discrete nature of the perimeter magnets results in a periodic change in response as the harvester is rotated. Due to the symmetric arrangement of the perimeter magnets, the response is repeated periodically every 360/n° of rotation, for n equally spaced and symmetrically positioned perimeter magnets. For the 12 perimeter magnet configuration presented, the response of the harvester is periodic every 30° of rotation. The resonant frequencies for a full rotation of the harvester are shown in FIG. 25 (which is a schematic for a convention of rotation of the harvester) and FIG. 26 (which is a graph of modeled resonant frequency vs. harvester rotation). It can be seen that the variation of resonant frequency based on angle of rotation is minimal and only about 0.2 Hz, or about 2.5%.

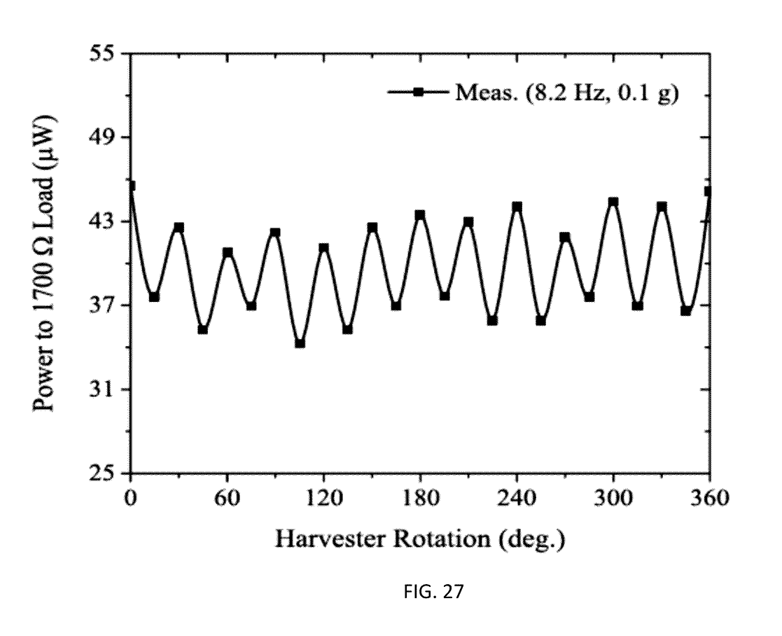

The measured power output can also be shown to remain fairly constant as a function of device rotation. This is shown in FIG. 27 (which is a graph of harvester's power with a 1700Ω load vs. harvester's rotation),where the device is rotated in increments of 30° and power output is measured. It can be observed that power output is greater when perimeter magnet is at the bottom, vs a gap in perimeter magnets, as shown in FIG. 25. This can likely be attributed to the fact that the resonant frequency increases slightly by adding 30° of rotation, and the new resonant frequency is higher than the excitation frequency of 8.2 Hz. The consistency of the device as it is rotated is still demonstrated, with power varying by about 7 μW, or about 17%.

In the general theory of operation, the levitating non-fixed magnet is suspended in position by the fixed magnet(s). Either the levitating magnet can be surrounded by the fixed magnets (FIG. 1), or the fixed magnet et can be bounded by the levitating magnet et (FIG. 5). As the device is accelerated along the plane of the device, the levitating magnet moves in any direction in the plane. As the levitating magnet moves, the flux through the coil changes thus causing a voltage to be generated on the coil, which can be harvested to power charge a battery. A conditioning circuit in at least some embodiments ensures that a positive charging voltage and/or current is provided to an energy storage device.

Those skilled in the art will recognize that numerous modifications can be made to the specific implementations described above. The implementations should not be limited to the particular limitations described. Other implementations may be possible.

1. A kinetic energy to electrical energy converter, comprising:
a housing defining a cavity having a circumference and covers enclosing the cavity;
at least one fixedly supported perimeter magnet disposed about the circumference;
at least one magnetically levitating center magnet magnetically influenced by the at least one fixedly supported magnet, disposed in the cavity and limited to substantially a two dimensional movement by the covers; and
at least one coil fixedly supported with respect to the fixedly supported perimeter magnet, movements of the at least one center magnet configured to generate an electrical current in the at least one coil.

2. The kinetic energy to electrical energy converter of claim 1, the at least one fixedly supported perimeter magnet is a plurality of perimeter magnets equi-distributed about the circumference, each with a first pole facing inward while the at least one center magnet configured to have the first pole facing outward.

3. The kinetic energy to electrical energy converter of claim 2, the plurality of perimeter magnets include 12 magnets.

4. The kinetic energy to electrical energy converter of claim 2, the at least one center magnet is a plurality of magnets.

5. The kinetic energy to electrical energy converter of claim 4, the plurality of center magnets includes 2 magnets.

6. The kinetic energy to electrical energy converter of claim 1, the at least one center magnet is a plurality of magnets.

7. The kinetic energy to electrical energy converter of claim 1, further comprising a signal detector configured to provide a motion detection signal corresponding to a threshold of a voltage across a load coupled to the at least one coil.

8. The kinetic energy to electrical energy converter of claim 1, further comprising an electrical storage circuit coupled to the at least one coil, the electrical storage circuit comprising:
a rectifying circuit configured to rectify current from the at least one coil; and
at least one storage device configured to receive the rectified current from the rectifying circuit.

9. The kinetic energy to electrical energy converter of claim 8, wherein the rectifying circuit comprises a plurality of diodes.

10. The kinetic energy to electrical energy converter of claim 9, wherein the plurality of diodes are arranged as a bridge.

11. A method of converting kinetic energy to electrical energy, comprising:
providing a fixedly supported perimeter magnet disposed in a housing defining a cavity having a circumference and covers enclosing the cavity;
levitating at least one center magnet magnetically influenced by the at least one fixedly supported magnet, disposed in the cavity and limited to substantially a two dimensional movement by the covers;
providing at least one coil fixedly supported with respect to the fixedly supported perimeter magnet; and
generating an electrical current in the at least one coil in response to movements of the at least one center magnet.

12. The method of claim 11, the at least one fixedly supported perimeter magnet is a plurality of perimeter magnets equi-distributed about the circumference, each with a first pole facing inward while the at least one center magnet configured to have the first pole facing outward.

13. The method of claim 12, the plurality of perimeter magnets include 12 magnets.

14. The method of claim 12, the at least one center magnet is a plurality of magnets.

15. The method of claim 14, the plurality of center magnets includes 2 magnets.

16. The method of claim 11, the at least one center magnet is a plurality of magnets.

17. The method of claim 11, further comprising detecting a motion detection signal corresponding to a threshold of a voltage across a load coupled to the at least one coil.

18. The method of claim 11, further comprising:
rectifying current from the at least one coil by a rectifying circuit; and
storing charge from the rectified current in at least one storage device.

19. The method of claim 18, wherein the rectifying circuit comprises a plurality of diodes.

20. The method of claim 19, wherein the plurality of diodes are arranged as a bridge.
